(19) United States
(12) Patent Application Publication
(10) Pub. No.: US 2015/0369288 A1
(43) Pub. Date: Dec. 24, 2015

(54) Metal/Plastic slide bearing composite material and slide bearing element produced therefrom

(71) Applicant: KS GLEITLAGER GMBH, St. Leon-Rot (DE)

(72) Inventors: Franz Cieslik, Heidelberg (DE); Rolf Reinicke, Bad Schoenborn (DE)

(73) Assignee: KS Gleitlager GmbH, St. Leon-Rot (DE)

(21) Appl. No.: 14/765,839

(22) PCT Filed: Feb. 7, 2014
(86) PCT No.: PCT/EP2014/052492

§ 371 Date: Aug. 5, 2015

(30) Foreign Application Priority Data
Feb. 8, 2013 (DE) 10 2013 202 121.6

(51) Int. Cl. F16C 33/20; F16C 33/14; C10M 111/04; F16C 33/12

(52) U.S. Cl. CPC F16C 33/201; F16C 33/206; F16C 33/128; F16C 33/145; C10M 111/04

(57) ABSTRACT

A metal/plastic slide bearing composite material (2) has a metallic support layer (4), especially of steel, and a porous carrier layer (6), especially a carrier layer (6) applied by sintering from metallic particles (7). A polymer-based slide layer material (8) completely fills the pores of the carrier layer (6) and has fillers that improve the tribological properties. The polymer basis is PTFE. The sliding layer material (8) has 0.1-5% by mass of carbon nanotubes with an external tube diameter of <80 nm and a tube length of <20 μm.

This application is the national stage of PCT/EP2014/052492 filed Feb. 7, 2014 and claims Paris convention priority from DE 10 2013 202 121.6 filed Feb. 8, 2013.

### BACKGROUND OF THE INVENTION

The invention concerns a metal/plastic slide bearing composite material having a metallic support layer, in particular of steel, having a porous carrier layer, in particular a carrier layer applied by sintering on metallic particles, and having a polymer-based slide layer material which fills the pores of the carrier layer and comprises fillers that improve the tribological properties, the polymer basis being PTFE.

The above-mentioned slide bearing composite materials have become widely known in the automotive sector, in particular for producing slide bearing elements. Slide bearing composite materials of this type having a slide layer material on the basis of PTFE are characterized by an extremely low coefficient of friction, wherein fillers and filler mixtures have become widely known which increase the wear resistance of the composite material.

The above statement that the polymer basis of the slide layer material is PTFE does not mean that the matrix-forming component of the slide layer material must consist of 100% PTFE but that also other matrix-forming polymers may be contained, as long as at least 75 weight %, in particular at least 80 weight %, in particular at least 90 weight %, in particular at least 95 weight % of the polymer component of the slide layer material is PTFE. However, the matrix-forming polymer component advantageously consists of 100% PTFE.

As mentioned above, fillers are added to the slide layer material in a conventional and usual manner in order to increase the wear resistance, wherein this is accompanied by a coefficient of friction increase as compared with a pure PTFE polymer basis, which must be accepted to a certain degree since the addition of fillers that increase the wear resistance is typically accompanied by a coefficient of friction increase. DE 10 2009 043 435 A1 discloses a sliding lacquer of non-analogous prior art which mentions, in addition to a plurality of other wear protection substances, carbon nanotubes as wear protection substance, which are not described in more detail. DE 10 2012 205 606 A1 describes carbon fibers as reinforcing fibers in a PTFE-based slide layer material comprising solid lubricants.

It is the underlying purpose of the present invention to optimize a metal/plastic slide bearing composite material of the above-described type in view of the described conflict of objectives of realizing an as low a coefficient of friction as possible and a high wear resistance.

### SUMMARY OF THE INVENTION

In accordance with the invention, this object is achieved in a slide bearing composite material of the mentioned type in that the slide layer material comprises 0.1 to 5 mass % of multi-walled carbon nanotubes with a tube outer diameter of ≦80 nm and a tube length of ≦20 μm.

It has surprisingly turned out that the addition of carbon nanotubes of the mentioned type not only increases or positively influences the wear resistance and other mechanical characteristic values of the slide bearing composite material but also reduces the coefficient of friction. This was highly surprising since one had assumed that PTFE-based slide layer materials cannot be further optimized with respect to their coefficient of friction. One had assumed that multi-walled carbon nanotubes allow a certain degree of displacement of the layers within the wall like telescoping nested cylinders, which has a positive effect on the tribological properties of the produced composite material. One had also assumed that the multi-walled carbon nanotubes can be distributed much more homogeneously in the slide layer material due to their much smaller volume compared with typical carbon fibers with diameters of between 3-5 μm and lengths of 100-1000 μm. This means that there are virtually always carbon nanotubes in any volume of the slide layer material no matter how small it may be.

Carbon nanotubes were discovered in the early nineties. They are concentric tube- or pipe-shaped structures of graphite or carbon atoms. The pipe walls or tubes are virtually formed of flat structures, rolled into a cylindrical shape, of flat monatomic hexagonal honeycomb-like layers of carbon atoms. The multi-walled carbon nanotubes have between 2 and 20 cylindrical tube walls or films of such layers. The radial separation between the layers within the tube structure is approximately in a region between 0.3 to 0.4 nm and corresponds to approximately 1.5 times the amount of the unit vector of the hexagonal structure. The winding axis or cylinder axis of the tube structure is perpendicular to the circular circumferential line. The circular circumferential line unrolled again into a flat shape describes, as a vector via indices n, m, the orientation of the tube winding with respect to the hexagonal honeycomb structure or with respect to their unit vectors. As indicated in FIG. 3, one identifies a winding with n=m which is designated as an arm chair, and a winding with n, m=0 which is designated as zigzag, and windings with arbitrary n, m which are designated as chiral. These arm chair, zigzag and chiral windings are preferred since they enable uniform, low-stress and therefore distortion-free formation of tubes. The most suitable is the armchair. All walls of the multi-walled carbon nanotubes advantageously have the same winding direction described by n and m.

In a further development of the invention, the tube outer diameter of the carbon nanotubes is advantageously ≦70 nm, in particular ≦60 nm, in particular ≦50 nm. The tube length of the carbon nanotubes is moreover advantageously ≦15 μm, in particular ≦10 μm, in particular ≦5 μm, in particular ≦3 μm, in particular ≦2 μm. The slide layer material moreover advantageously comprises 0.1 to 4 mass %, in particular 0.5 to 4 mass %, in particular 1-4 mass %, in particular 1-3.5 mass % of carbon nanotubes.

It also turned out that the orientation of the carbon nanotubes in the direction of the sliding strain entails further advantages with respect to reduction or minimization of the coefficient of friction.

It may also turn out to be advantageous for the slide layer material to comprise 1-40 mass %, in particular 1-30 mass %, in particular 1-25 mass %, in particular 5-25 mass %, in particular 10-25 mass % of further fillers (in addition to carbon nanotubes).

Other feasible fillers are: reinforcing substances such as, in particular C-fibers, glass fibers, polyamide fibers (aramid); solid lubricants such as ZnS, BaSO₄, graphite, carbon black, hexagonal boron nitride; metal sulfides such as MoS₂, SnS₂, WS₂, plastic particles such as, in particular aramid (PPTA)-, PPSO₂-, PI- and PAI-particles, polyacrylate particles (PAR), PBA, PBI; metal oxides such as, in particular Fe₂O₃, Al₂O₃, SiO₂, TiO₂, CuO, MgO, ZnO; hard materials (ceramic particles) such as, in particular SiC, Si₃N₄, BC, cubic boron nitride; fluorides such as, in particular CaF₂, NaF, AlF₃; sheet silicates such as, in particular kaolin, mica, wollastonite, talcum, silicic acid; metallic fine powders such as, in particular bronze and bismuth; and pigments such as, in particular mixed phase oxide pigments, namely Co—Al, Cr—Sb—Ti, Co—Ti, Fe—Al or Co—Cr.

It has turned out to be particularly useful for the further fillers to comprise reinforcing substances, in particular carbon fibers.

It also turned out to be advantageous for the further fillers to comprise solid lubricants, in particular graphite or hexagonal boron nitride.

It also turned out to be advantageous for the further fillers to comprise metal sulfides, in particular MoS₂ or ZnS.

Protection is furthermore also claimed for a slide bearing element produced from a slide bearing composite material, in particular in a rolling bending forming process or in a deep-drawing process. Sliding elements of this type are typically rolled cylindrical bushings or semi-shell-shaped slide bearing elements. Collar bushings or pot-shaped bushings or flat or spherical slide bearing elements are also feasible.

Further details, features and advantages of the invention can be extracted from the attached claims and the following description and drawing of preferred embodiments of the invention.

### BRIEF DESCRIPTION OF THE DRAWING

FIG. 1 shows a schematic sectional view of an inventive metal/plastic slide bearing composite material;

FIG. 2 shows measurement results of the coefficient of friction of slide bearing elements produced from slide bearing composite materials in accordance with the invention; and

FIG. 3 shows the winding direction for forming carbon nanotubes on the basis of monatomic hexagonal carbon layers.

### DESCRIPTION OF THE PREFERRED EMBODIMENT

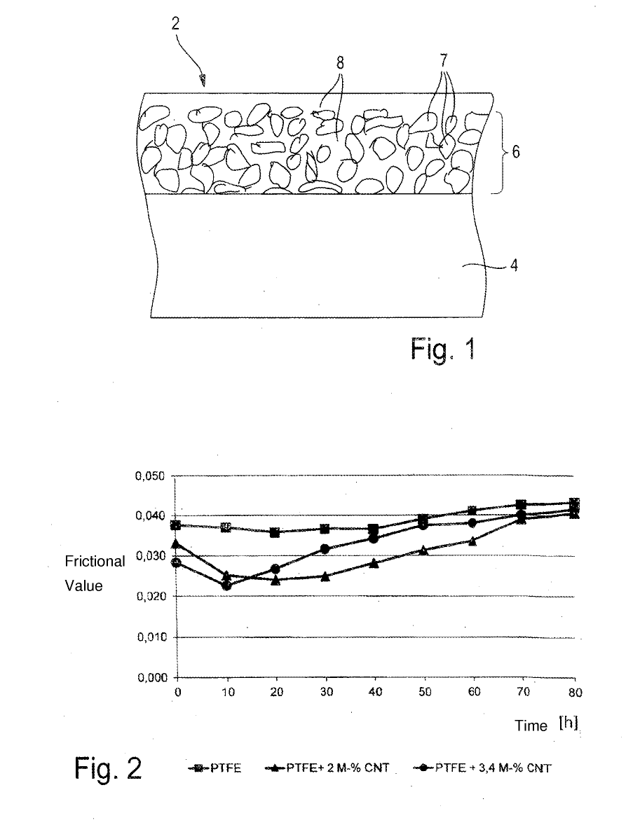

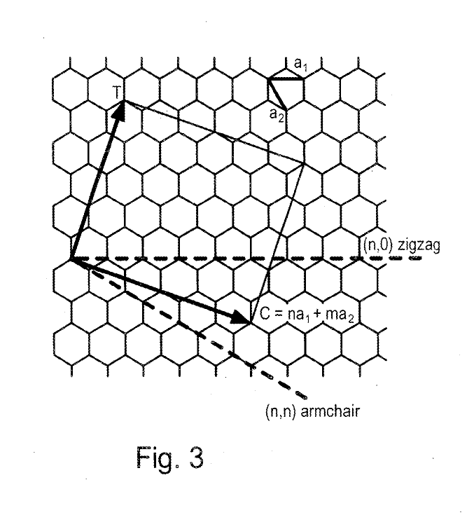

FIG. 1 shows a schematic sectional view of an inventive slide bearing composite material 2 comprising a metallic support layer 4, typically of steel, and a porous carrier layer 6. The porous carrier layer 6 is formed by a sinter layer of metallic particles 7 on the basis of bronze. The particles of the carrier layer 6 form contiguous macroscopic cavities (which are not shown true to scale), into which a slide layer material 8 on the basis of polymers is impregnated. The slide layer material 8 substantially completely fills the pores of the carrier layer. The matrix-forming polymer component of the slide layer material 8 is based on PTFE as defined in the beginning. The polymer component advantageously consists of PTFE. The slide layer material 8 moreover comprises fillers which are received in the matrix-forming polymer component. In accordance with the invention, the slide layer material 8 comprises between 0.1 and 5 mass % of carbon nanotubes of the above-described type which are, however, not illustrated in the drawing. Further fillers in addition to carbon nanotubes may turn out to be advantageous and are also not illustrated. In particular, the above-mentioned fillers are suitable in this case. Reinforcing substances, in particular carbon fibers, solid lubricants, in particular graphite or hexagonal boron nitride and metal sulphides are particularly suited.

FIG. 2 shows the result of coefficient of friction measurements on slide bearing elements, which were measured on slide bearing composite materials of the following composition. The slide bearing composite materials comprise a metallic support layer of steel, a porous carrier layer of the above-described type and a slide layer material that fills the pores of the support layer and is based on polymers. The examined slide bearing elements differ with respect to the composition of the slide layer material. In the slide bearing element 1), the slide layer material consists of 100 mass % of PTFE without fillers. In 2), the slide layer material consists of 98 mass% of PTFE and 2 mass % of carbon nanotubes. In 3), it consists of 96.6 mass % of PTFE and 3.4 mass % of carbon nanotubes. One can see that the addition of carbon nanotubes reduces the coefficient of friction, which was highly surprising.

For producing the inventive slide bearing composite material, a PTFE dispersion is formed in a conventional manner to which carbon nanotubes are added within the claimed scope. This dispersion is then coagulated and impregnated into the pores of the porous carrier layer, advantageously in a rolling process, and further processed through temperature treatment.

1-15. (canceled)

16. Metal/plastic slide bearing composite material, the slide bearing composite material comprising:
a metallic support layer or a metallic support layer of steel;
a porous carrier layer in direct contact with said metallic support layer or a porous carrier layer applied on said metallic support layer by sintering on metallic particles; and
a polymer-based slide layer material which fills pores of said porous carrier layer and comprises fillers that improve tribological properties, said slide layer material having a PTFE polymer basis, wherein said slide layer material comprises 0.1 to 5 mass % of multi-walled carbon nanotubes with a tube outer diameter of ≦80 nm and a tube length of ≦20 μm.

17. The slide bearing composite material of claim 16, wherein the tube outer diameter of said carbon nanotubes is ≦70 nm, ≦60 nm or ≦50 nm.

18. The slide bearing composite material of claim 16, wherein a tube length of said carbon nanotubes is ≦15 μm, ≦10 μm, ≦5 μm, ≦3 μm or ≦2 μm.

19. The slide bearing composite material of claim 16, wherein the slide layer material comprises 0.1 to 4 mass %, 0.5 to 4 mass %, 1-4 mass % or 1-3.5 mass % of carbon nanotubes.

20. The slide bearing composite material of claim 16, wherein said multi-walled carbon nanotubes comprise 2 to 20 walls.

21. The slide bearing composite material of claim 16, wherein said carbon nanotubes are wound in an arm chair winding direction, in a zigzag orientation or chiral.

22. The slide bearing composite material of claim 16, wherein walls of said multi-walled carbon nanotubes have a same winding direction.

23. The slide bearing composite material of claim 16, wherein said carbon nanotubes are oriented in a direction of sliding strain.

24. The slide bearing composite material of claim 16, wherein the slide layer material comprises 1-40 mass %, 1-30 mass %, 1-25 mass %, 5-25 mass % or 10-25 mass % of further fillers.

25. The slide bearing composite material of claim 24, wherein said further fillers are reinforcing substances, C-fibers, glass fibers, polyamide fibers, aramid fibers, solid lubricants, ZnS, BaSO₄, graphite, carbon black, hexagonal boron nitride, metal sulphides, MoS₂, SnS₂, WS₂, plastic particles, aramid particles, PPTA particles, PPSO₂ particles, PI particles, PAI particles, polyacrylate particles, PAR, PBA, PBI, metal oxides, Fe₂O₃, Al₂O₃, SiO₂, TiO₂, CuO, MgO, ZnO, hard materials, ceramic particles, SiC, Si₃N₄, BC, cubic boron nitride, fluorides, CaF₂, NaF, AlF₃, sheet silicates, kaolin, mica, wollastonite, talcum, silicic acid, metallic fine powders, bronze, bismuth, pigments, mixed phase oxide pigments, Co—Al, Cr—Sb—Ti, Co—Ti, Fe—Al or Co—Cr.

26. The slide bearing composite material of claim 24, wherein said further fillers comprise reinforcing substances or carbon fibers.

27. The slide bearing composite material of claim 24, wherein said further fillers comprise solid lubricants, graphite or hexagonal boron nitride.

28. The slide bearing composite material of claim 24, wherein said further fillers comprise metal sulfides, MoS₂ or ZnS.

29. The slide bearing composite material of claim 16, wherein said slide layer material forms a projection past said porous carrier layer.

30. The slide bearing composite material of claim 29, wherein said projection has a thickness of 5-30 μm, 30-80 μm, ≧80 μm or of 80-150 μm.

31. A slide bearing element produced from the slide bearing composite material of claim 16.

32. The slide bearing element of claim 31, wherein the element is produced in a rolling bending forming process or in a deep-drawing process.
